(19) United States
(12) Patent Application Publication
(10) Pub. No.: US 2026/0302892 A1
(43) Pub. Date: Oct. 1, 2026

(54) HEAT DISSIPATION STRUCTURES FOR PRINTED CIRCUIT BOARD (PCB) STATOR ASSEMBLIES

(71) Applicant: AIRGREENING (CANADA) INC., Markham (CA)

(72) Inventors: Jixian HU, Richmond Hill (CA); Yuehao HU, Richmond Hil (CA); Jiawen ZHU, Toronto (CA)

(21) Appl. No.: 19/095,513

(22) Filed: Mar. 31, 2025

Related U.S. Application Data
(63) Continuation of application No. PCT/IB2025/053142, filed on Mar. 25, 2025.

(51) Int. Cl. H02K 9/22; H02K 3/26

(52) U.S. Cl. CPC H02K 9/227; H02K 3/26; H02K 2203/03; H02K 2211/03

(57) ABSTRACT

A printed circuit board (PCB) stator includes: a substrate having a perimeter wall; an external terminal; a set of conductive traces disposed on the substrate orthogonal to the perimeter wall, the conductive traces electrically connected with the external terminal, and defining (i) a plurality of stator lobes, and (ii) an extension from at least one of the stator lobes towards the perimeter wall; and a heatsink affixed to the perimeter wall and electrically connected with the extension.

### CROSS-REFERENCE TO RELATED APPLICATIONS

This application is a continuation of PCT Application No. PCT/IB2025/053142, filed Mar. 25, 2025, the entire contents of which is incorporated herein by reference.

### FIELD

The specification relates generally to electrical motor-generators, and specifically to heat dissipation structures for printed circuit board (PCB) stator assemblies.

### BACKGROUND

PCB-based electric motor-generators, which employ PCBs carrying conductive traces to define stator coils, for example, may provide one or more of increased reliability, decreased weight, and decreased material costs relative to power generation, in comparison with coiled wire-based motor-generators. Examples of PCB-based stators are described in U.S. Patent No. 10141803. PCB-based stators, however, may struggle with heat dissipation, which may necessitate the use of complex and costly cooling solutions.

### SUMMARY

An aspect of the specification provides a printed circuit board (PCB) stator, comprising: a substrate having a perimeter wall; an external terminal; a set of conductive traces disposed on the substrate orthogonal to the perimeter wall, the conductive traces electrically connected with the external terminal, and defining (i) a plurality of stator lobes, and (ii) an extension from at least one of the stator lobes towards the perimeter wall; and a heatsink affixed to the perimeter wall and electrically connected with the extension.

Another aspect of the specification provides an axial flux motor-generator, comprising: a housing; a PCB stator as recited above; supported within the housing; and a rotor adjacent to the PCB stator, the rotor supported within the housing to rotate about the axis of rotation.

### BRIEF DESCRIPTIONS OF THE DRAWINGS

Embodiments are described with reference to the following figures.

FIG. 1 depicts an example PCB stator.

FIG. 2 depicts a partially exploded view of the PCB stator of FIG. 1.

FIG. 3 depicts another example PCB stator.

FIG. 4 depicts a partially exploded view of the PCB stator of FIG. 3.

FIG. 5 depicts a further example PCB stator.

FIG. 6 depicts conductive traces forming one phase of the PCB stator of FIG. 5.

FIG. 7 depicts a diagram of a motor-generator incorporating a PCB stator.

### DETAILED DESCRIPTION

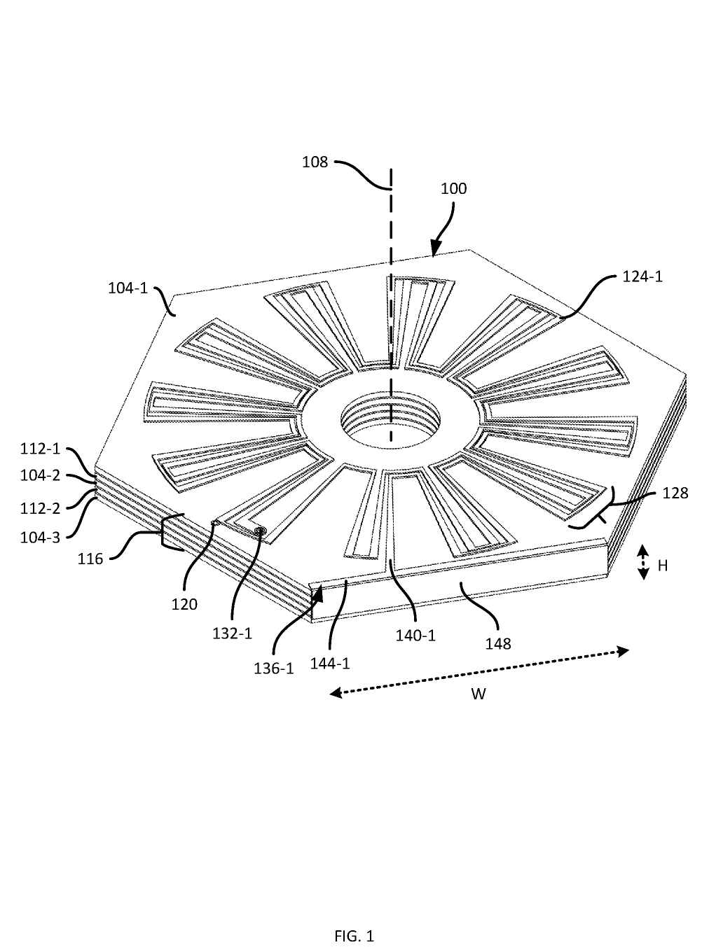

FIG. 1 illustrates a single-phase PCB stator 100, e.g., configured to generate electrical power in the presence of a spinning rotor assembly (not shown), and/or configured to generate rotary motion in such a rotor assembly when power is supplied to the PCB stator 100 from an external source. The stator 100 includes at least one substrate member 104. In the illustrated example, the stator 100 includes three substrates 104-1, 104-2, and 104-3 (also referred to collectively as the substrates 104, or generically as a substrate 104; similar nomenclature is used elsewhere herein for components with hyphenated reference numbers), each centered on an axis of rotation 108. The axis 108, for example, can be the axis about which the above-mentioned rotor assembly spins.

The substrates 104 can be two-sided PCBs, e.g., each including a layer of dielectric material with conductive (e.g., copper) traces on either side. The substrates 104 can have substantially equal shapes and dimensions, as shown in FIG. 1, and can be stacked, with an insulator (e.g., a member of FR4 or other suitable dielectric material) 112-1, 112-2 separating each pair of adjacent substrates 104. In other examples, as will be apparent in the discussion below, the stator 100 can have fewer than the three substrates 104 shown in FIG. 1, or a greater number of substrates 104. In some examples, the stator 100 may include a single substrate 104, and the insulators 112 can be omitted. The substrates 104 and insulators 112 can be affixed to one another to form the stacked arrangement shown in FIG. 1 by any suitable adhesive or other fastening process.

Each substrate 104, and each insulator 112, includes a perimeter wall extending around the edge of the substrate 104 or insulator 112. The shape and size of each planar segment of the perimeter walls is dependent on the shape and size of the substrate 104 or insulator 112. In the illustrated example, the substrates 104 and insulators 112 are hexagonal, and each of the six perimeter wall segments of each substrate 104 and insulator 112 are coplanar with corresponding segments of the other substrates 104 and insulators 112, such that the stator 100 has a collective perimeter wall 116.

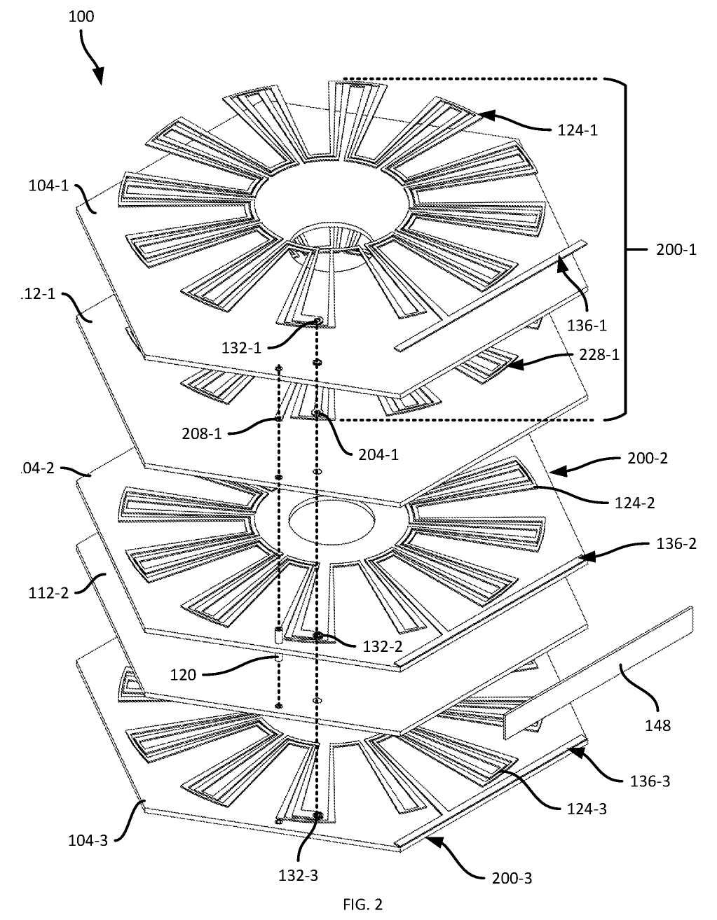

The stator 100 includes an external terminal 120, e.g., to supply power to a load (not shown) when operating as a generator, and/or to receive power from a power source (not shown) when operating as a motor. The stator 100 also includes a plurality of conductive traces, e.g., copper traces or traces of other suitable conductive material. The traces can be etched, deposited, or fabricated according to any other manufacturing process. The conductive traces are disposed on at least one surface of the substrate 104, and are on planes that are substantially orthogonal to the perimeter wall 116. In this example, a first subset of conductive traces 124-1 is shown on a first surface of the substrate 104-1. As will be discussed in connection with FIG. 2, the stator 100 includes an additional subset of traces on an opposing surface of the substrate 104-1, and the substrates 104-2 and 104-3 each include respective pairs of conductive traces.

The conductive traces are electrically connected with the external terminal 120. In the example shown in FIG. 1, the subset of traces 124-1 are not connected with the external terminal 120 on the visible surface of the substrate 104-1. Instead, as discussed below, the subset 124-1 is electrically connected with the external terminal 120 via further subsets of traces. The conductive traces define a plurality of stator lobes 128. Twelve lobes are shown in FIG. 1, although it will be understood that a variety of other lobe configurations can be employed, depending on the desired performance characteristics of the stator 100. In this example, the subset of traces 124-1 defines the lobes 128 in a continuous crenellated, or wave-shaped, spiral beginning at a first end 132-1 and encircling the axis 108 twice before terminating at an extension 136-1. As will be seen below, it is not necessary of every subset of traces to include an extension, but at least some subsets include extensions. The extension 136-1 extends from the corresponding lobe 128 towards the perimeter wall 116. In this example, the extension includes a radial arm 140-1 extending radially away from the axis 108 towards the perimeter wall 116, and a transverse arm 144-1 extending along the perimeter wall 116. The transverse arm 144-1 is connected with a heatsink 148 with an inner surface affixed to the perimeter wall 116, and an opposing outer surface (visible in FIG. 1) facing away from the perimeter wall 116. In this example, the heatsink 148 is a planar member, e.g., rectangular in shape with a height H substantially equal to the height of the stator 100, and a width W substantially equal to a width of one hexagonal side of the substrates 104. The heatsink 148 can be formed by any suitable electroplating process, for example, and can have a thickness dependent on design specifications and process capabilities. Other heatsink shapes and dimensions are also contemplated, however. The heatsink can be a plate of conductive material, e.g., the same conductive material (e.g., copper) used to fabricate the conductive traces of the subset 124-1.

Turning to FIG. 2, a partially exploded view of the stator 100 is shown. In particular, a first assembly 200-1 including the substrate 104-1, the subset 124-1 and a subset 228-1 of conductive traces is shown exploded, while two other assemblies 200-2 and 200-3, separated by the insulator 112-2, are shown intact. The subset 228-1 of traces is disposed on an opposite side of the substrate 104-1 from the subset 124-1, and defines matching lobes to the lobes 128. In addition, the subset 228-1 includes a terminal 204-1 that is connected to the end 132-1 by a conductive via extending through the substrate 104-1. The subset 228-1 also includes an end 208-1 that is electrically connected to the external terminal 120. The subset 228-1 is therefore also connected with the heatsink 148, via the subset 124-1.

As will be apparent, each of the assemblies 200-2 and 200-3 also includes a corresponding subset 124-2, 124-3 with ends 132-2 and 132-3 and extensions 136-2 and 136-3. Each of the assemblies 200-2 and 200-3 also includes corresponding subsets 228 (not shown in FIG. 2), as well as corresponding extensions 136-2, 136-3. The heatsink 148 is therefore connected to all three assemblies 200, via the extensions 136. Thus, heat generated in the conductive traces of the subsets 124 and 228 can be dissipated to an exterior of the stator 100 via the heatsink 148. As will also be apparent, the external terminal 120 and the heatsink 148 connect the subsets of traces 124 and 228 in parallel with one another.

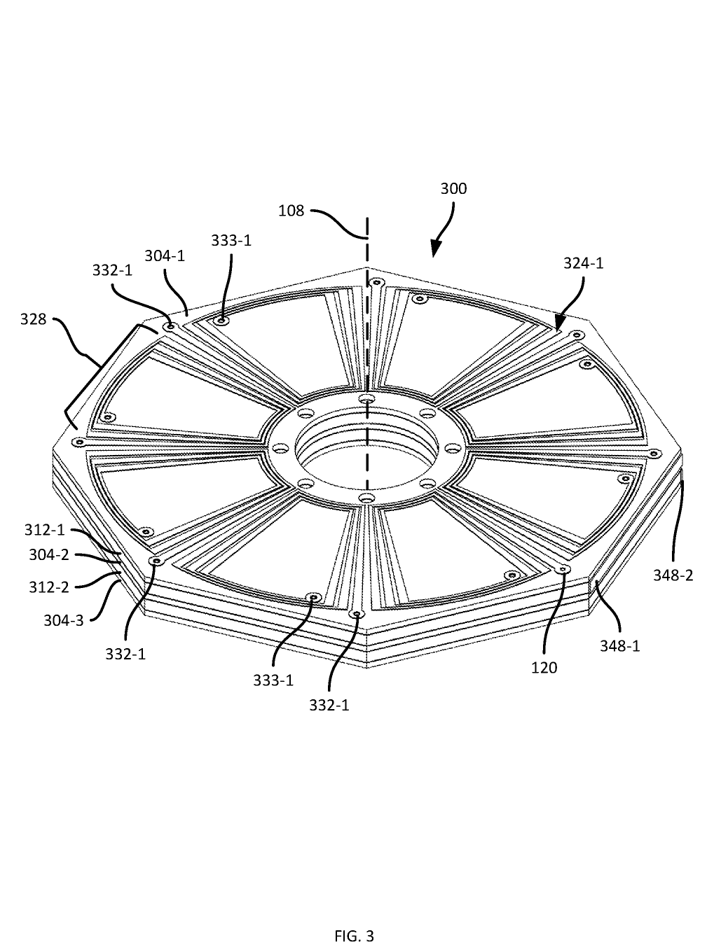

FIG. 3 illustrates a single-phase stator 300 according to a further embodiment. While the stator 100 includes three sets of lobes in a stacked arrangement (defined by the assemblies 200-1, 200-2, and 200-3) connected to one another in parallel, the stator 300 includes three sets of lobes 328 in a stacked arrangement, connected with one another in series. Reference numbers in the discussion below with a leading “3” and suffixes that are equivalent to those described above are as described in connection with the components described earlier, unless where specified below. For example, the stator 300 includes substrates 304-1, 304-2, 304-3, that are substantially as described above in connection with the substrates 104-1, 104-2, and 104-3. The substrates 304, however, are octagonal in this example. The stator 300 also includes insulators 312-1 and 312-2 separating the substrates 304.

The stator 300 includes a first subset of conductive traces 324-1, on a first surface of the substrate 304-1. The conductive traces 324-1 define a plurality of lobes 328 (eight lobes, in this example) in the form of spiral coils each having ends 332-1 and 333-1. Each lobe 328 as shown in FIG. 3 is electrically connected to an adjacent lobe 328, via connections to another subset of traces on the opposite side of the substrate 304-1. The stator 300 also includes an external terminal 120, corresponding to an end of one of the lobes 332-1.

The stator 300 also includes a first heatsink 348-1, and a second heatsink 348-2. Each of the heatsinks 348 are affixed to the perimeter wall of the stator 300. In this example, the heatsinks 348 are affixed to different faces of the perimeter wall, and have widths substantially equal to the length of such faces, and heights that are smaller that the height of the perimeter wall of the stator 300. For example, each heatsink 348 may have a height that is substantially equal to a thickness of each insulator 312. In other examples, the height of each heatsink 348 can be equal to the sum of (i) the thickness of an insulator 312, (ii) the thickness of an adjacent two-sided PCB (e.g., a substrate 304 and the copper traces on either side thereof), and (iii) a thickness of a single copper trace layer.

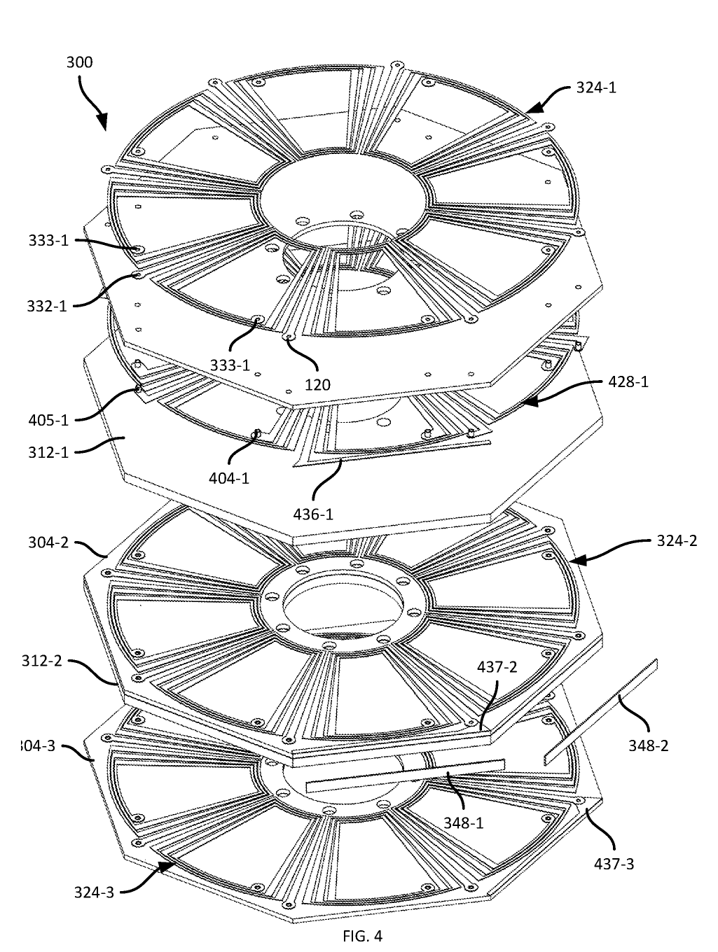

Turning to FIG. 4, a partially exploded view of the stator 300 is shown. The substrate 304-1 includes a second subset of traces 428-1 on an opposite side from the subset of traces 324-1. The subset 328-1 includes an extension 436-1 from one of the spiral coils defining a matching set of lobes to the lobes 328. The extension 436-1 is connected to the heatsink 348-1 (specifically, to a top edge of the heatsink 348-1).

Each lobe (e.g., each of the eight coils of the subset 128) includes ends 404-1 and 405-1. The end 404-1 is configured to connect to the end 333-1 of the subset 324-1 directly opposite through the substrate 304-1. The end 405-1 is configured to connect to the end 332-1 directly opposite through the substrate 304-1. The coils of the subsets 324-1 and 328-1 are therefore connected to one another in a series, alternating between the subset 324-1 and the subset 328-1, and extending from the external terminal 120 to the end 333-1 of the lobe 128 immediately to the left (in this view) of the terminal 120.

Each substrate 304-2 and 304-3 also includes conductive traces with the above features. In addition, the subset of traces 324-2 on the substrate 304-2 also includes an extension 437-2 configured to contact the lower edge of the heatsink 348-1. In other words, the heatsink 348-1 connects the subset of traces 428-1 with the subset 424-2 in series. The substrate 304-2 also supports a subset of traces 328 on the opposite side thereof from the subset 324-2, and that subset (not visible in FIG. 4) includes an extension structurally similar to the extension 436-1, for contacting the upper edge of the heatsink 348-2. The heatsink 348-2 also contacts an extension 437-3 on the substrate 304-3, and thus connects the subset on the underside of the substrate 304-2 with a subset 324-3 on the substrate 304-3, in series.

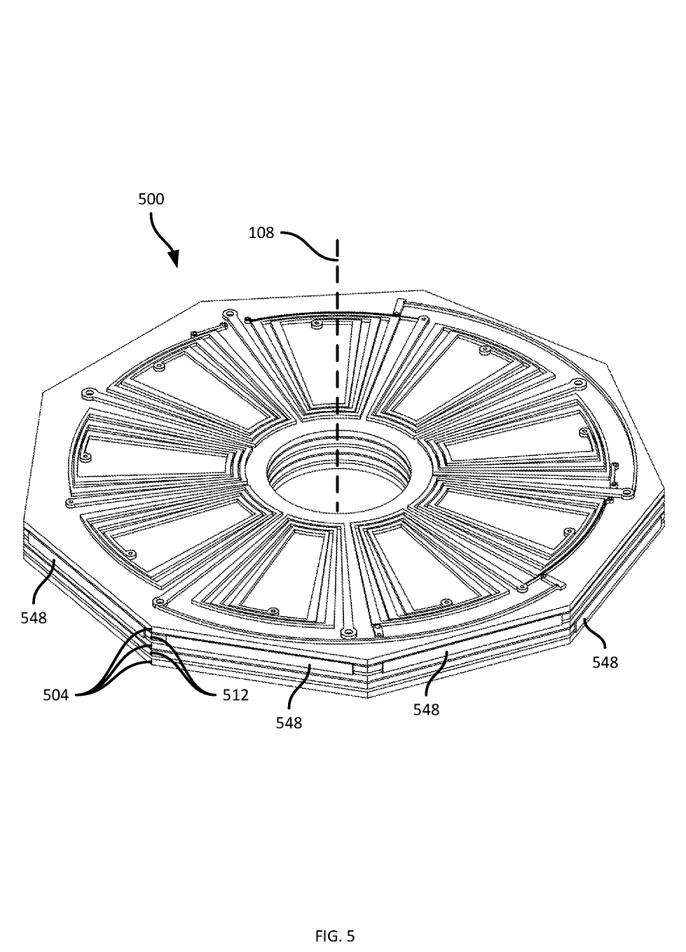

More complex arrangements of conductive traces are also contemplated, while implementing one or more heatsinks affixed to the perimeter wall of the stator, which can serve to connect subsets of conductive traces in series or in parallel. For example, FIG. 5 illustrates a further example PCB stator 500, including a plurality of substrates 504 (three, in this example) separated by insulators 512. The stator 500 can include conductive traces forming lobes that are similar in shape to those of the stator 300 (e.g., wedge-shaped spiral coils). In contrast to the stator 300, however, the stator 500 can have a three-phase configuration. Each subset of traces, for example, can include nine lobes divided into three interconnected sets of three lobes each. Each set of three lobes can be connected to a distinct heatsink 548, which in turn connects to a corresponding set of three lobes on the next substrate 504. Further traces on the next substrate connect to a further heatsink 548, which connects to the final substrate 504. In other words, the example shown in FIG. 5 includes six heatsinks 548, e.g., two heatsinks 548 for each phase.

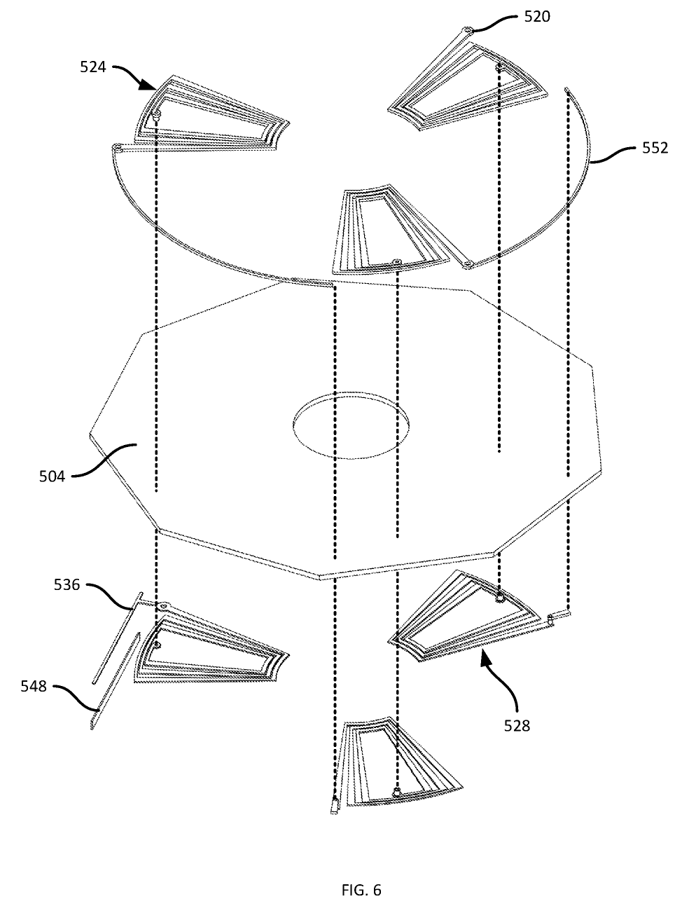

FIG. 6 illustrates the components of one phase for one substrate 504. In particular, the substrate 504 supports a subset of traces 524 on one side, and a subset of traces 528 on the other side. The subsets 524 and 528 are interconnected through the substrate 504, as shown by the dashed lines, except in the case of the external terminal 520. The heatsink 548 connects the illustrated traces to a corresponding set of traces on the next substrate 504. The other two phases have similar structures, although the connections 552 between lobes vary between phases to avoid obstructing each other.

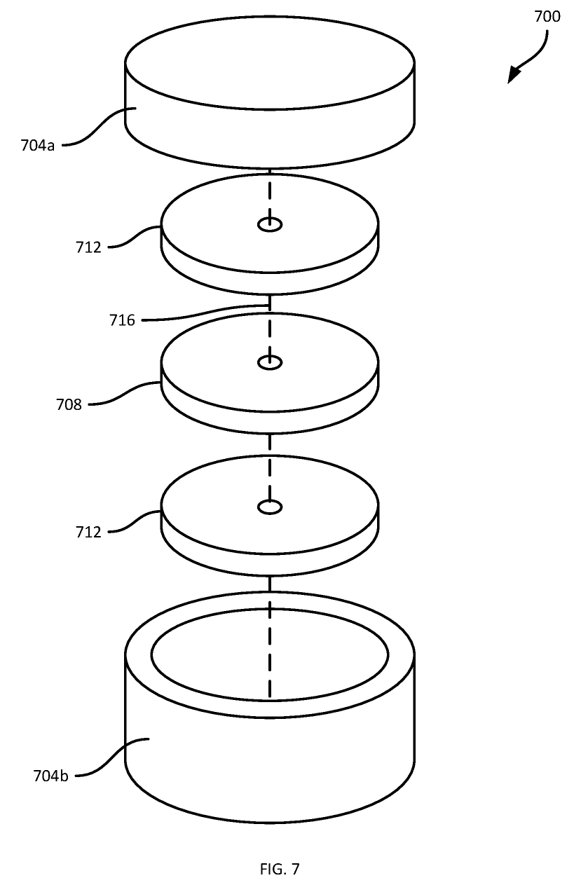

Turning to FIG. 7, as will be apparent, the PCB stators described above can be components of a motor-generator 700, shown in exploded form. The motor-generator 700 can include a housing 704a, 704b containing a stator 708 (e.g., any of the above-described stators) and one or more rotors 712 (e.g., one rotor on each side of the stator 708). The rotors 712 are mounted for rotation about an axis 716, e.g., defined by spindles or the like supported within the housing 704.

The scope of the claims should not be limited by the embodiments set forth in the above examples, but should be given the broadest interpretation consistent with the description as a whole.

1. A printed circuit board (PCB) stator, comprising:
a substrate having a perimeter wall;
an external terminal;
a set of conductive traces disposed on the substrate orthogonal to the perimeter wall, the conductive traces electrically connected with the external terminal, and defining (i) a plurality of stator lobes, and (ii) an extension from at least one of the stator lobes towards the perimeter wall; and
a heatsink affixed to the perimeter wall and electrically connected with the extension.

2. The PCB stator of claim 1, wherein the heatsink includes a planar member having an inner surface affixed to the perimeter wall and connected with the extension, and an opposing outer surface facing away from the perimeter wall.

3. The PCB stator of claim 1, wherein the set of conductive traces comprises:
a first subset of traces disposed on a first side of the substrate; and
a second subset of traces disposed on a second side of the substrate and connected with the first subset with a via extending through the substrate;
wherein at least one of the first and second subsets include the extension.

4. The PCB stator of claim 1, further comprising:
a second substrate having a second perimeter wall;
an insulator separating the first substrate from the second substrate; and
a second set of conductive traces disposed on the second substrate orthogonal to the second perimeter wall, the second set of conductive traces defining (i) a second plurality of stator lobes, and (ii) a second extension from at least one of the second plurality of stator lobes towards the second perimeter wall.

5. The PCB stator of claim 4, wherein the second set of conductive traces are electrically connected with the external terminal in parallel with the set of conductive traces.

6. The PCB stator of claim 5, wherein the second extension contacts the heatsink.

7. The PCB stator of claim 4, wherein the second set of conductive traces are electrically connected in series with the set of conductive traces.

8. The PCB stator of claim 7, wherein the second extension and the heatsink connect the second set of conductive traces with the set of conductive traces.

9. The PCB stator of claim 4, wherein the perimeter wall and the second perimeter wall are coplanar.

10. The PCB stator of claim 1, wherein the heatsink has a length extending along a portion of the perimeter wall, and a height substantially equal to a height of the perimeter wall.

11. The PCB stator of claim 1, further comprising:
a plurality external terminals including the external terminal, the external terminals corresponding to respective phases of the PCB stator;
wherein the set of conductive traces includes respective subsets of conductive traces each defining (i) a corresponding plurality of stator lobes electrically connected with a respective one of the external terminals, and (ii) a corresponding extension towards the perimeter wall.

12. The PCB stator of claim 1, wherein the plurality of stator lobes are disposed about an axis of rotation.

13. An axial flux motor-generator, comprising:
a housing;
a PCB stator according to claim 12 supported within the housing; and
a rotor adjacent to the PCB stator, the rotor supported within the housing to rotate about the axis of rotation.
